(19) United States
(12) Patent Application Publication
(10) Pub. No.: US 2011/0225579 A1
(43) Pub. Date: Sep. 15, 2011

(54) CONFIGURABLE SOFTWARE DEPLOYMENT

(76) Inventor: Nikhil Khandelwal, Kirkland, WA (US)

(21) Appl. No.: 12/722,545

(22) Filed: Mar. 12, 2010

(51) Int. Cl. G06F 9/445

(52) U.S. Cl. 717/177

(57) ABSTRACT

Methods, systems, and computer-readable media for configurable software deployment are disclosed. A particular method includes, at a first computing device, identifying a deployment configuration associated with a software package that is deployable to a second computing device. A first sequence of deployment actions is selected from a list of available deployment actions. The first sequence of deployment actions is executable to install the software package at the second computing device. When an installation operation associated with the deployment configuration is selected, the first sequence of deployment actions is executed to install the software package at the second computing device.

### BACKGROUND

Software applications are often accessible to multiple parties. For example, a database application may be hosted at a database server that is accessible to multiple database client machines. Typically, an integrated development environment (IDE) used to define a software application provides preconfigured and immutable deployment options. However, the preconfigured deployment options may not be well-suited to all software deployment scenarios.

### SUMMARY

A framework for configurable software deployment is disclosed. The framework may enable users to define new deployment configurations and to edit existing deployment configurations. Each deployment configuration may include a sequence of installation actions (e.g., to install a software package) and a sequence of retraction actions (e.g., to “roll back” or uninstall the software package). The framework may also enable users to reorder the sequences of install actions and retraction actions for individual deployment configurations. For example, the framework may provide graphical user interfaces (GUIs) to create, define, select, and reorder deployment configurations and sequences of actions.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a diagram to illustrate a particular embodiment of a system of configurable software deployment;

FIG. 2 is a diagram to illustrate another particular embodiment of a system of configurable software deployment;

FIG. 3 is a diagram to illustrate a particular embodiment of a graphical user interface (GUI) useable to configure software deployment;

FIG. 4 is a diagram to illustrate a particular embodiment of a GUI useable to create and update software deployment;

FIG. 5 is a diagram to illustrate a particular embodiment of a GUI useable to configure a clean software deployment;

FIG. 6 is a flow diagram to illustrate a particular embodiment of a method of configuring a software deployment;

FIG. 7 is a flow diagram to illustrate a particular embodiment of a method of configuring and executing software deployment or retraction;

FIG. 8 is a flow diagram to illustrate a particular embodiment of a method of providing GUIs usable to configure software deployment; and

FIG. 9 is a block diagram of a computing environment including a computing device operable to support embodiments of computer-implemented methods, computer program products, and system components as illustrated in FIGS. 1-8.

### DETAILED DESCRIPTION

In a particular embodiment, a computer-implemented method includes, at a first computing device, identifying a deployment configuration associated with a software package that is deployable to a second computing device. The method also includes defining a first sequence of deployment actions selected from a list of deployment actions associated with the identified deployment configuration. The first sequence of deployment actions can be executed to install the software package at the second computing device (e.g., upon receiving a selection of an “install” option associated with the deployment configuration). A second sequence of deployment actions (which may or may not include overlapping deployment actions with the first sequence) may be defined and executed to retract the software package from the second computing device (e.g., upon receiving a selection of a “retract” option associated with the deployment configuration). The second computing device may be remotely located from the first computing device (e.g., a web server) or may be co-located, such as a network-accessible portion of the first computing device (e.g., a locally-hosted web site).

In another particular embodiment, a computer-readable medium includes instructions, that when executed by a computer, cause the computer to receive a selection of a deployment configuration associated with a software package that is deployable to a second computing device. The deployment configuration includes a set of actions. A first subset of the set of actions is associated with an install operation that installs the software package at the second computing device and a second subset of the set of actions is associated with a retract operation that retracts the software package from the second computing device. The instructions also cause the computer to receive a selection either the install operation or the retract operation. The instructions further cause the computer to execute the first subset of actions when the install operation is selected and to execute the second subset of actions when the retract operation is selected.

In another particular embodiment, a computer-readable medium includes instructions, that when executed by a computer, cause the computer to display a first graphical user interface (GUI) useable to select an active deployment configuration from a list of available deployment configurations associated with a software package that is deployable to a second computing device. The instructions also cause the computer to display a second GUI useable to add a new deployment configuration to the list of available deployment configurations. The second GUI includes a first GUI control to define a first sequence of deployment actions to install the software package at the second computing device and a second GUI control to define a second sequence of deployment actions to retract the software package from the second computing device.

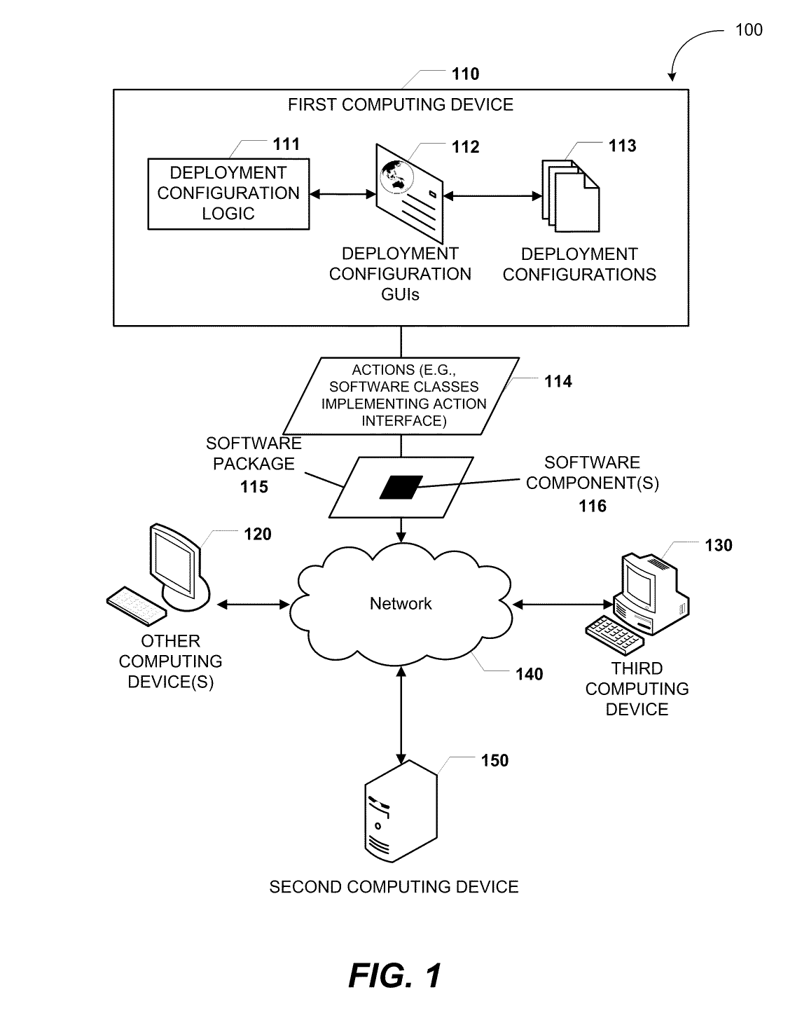

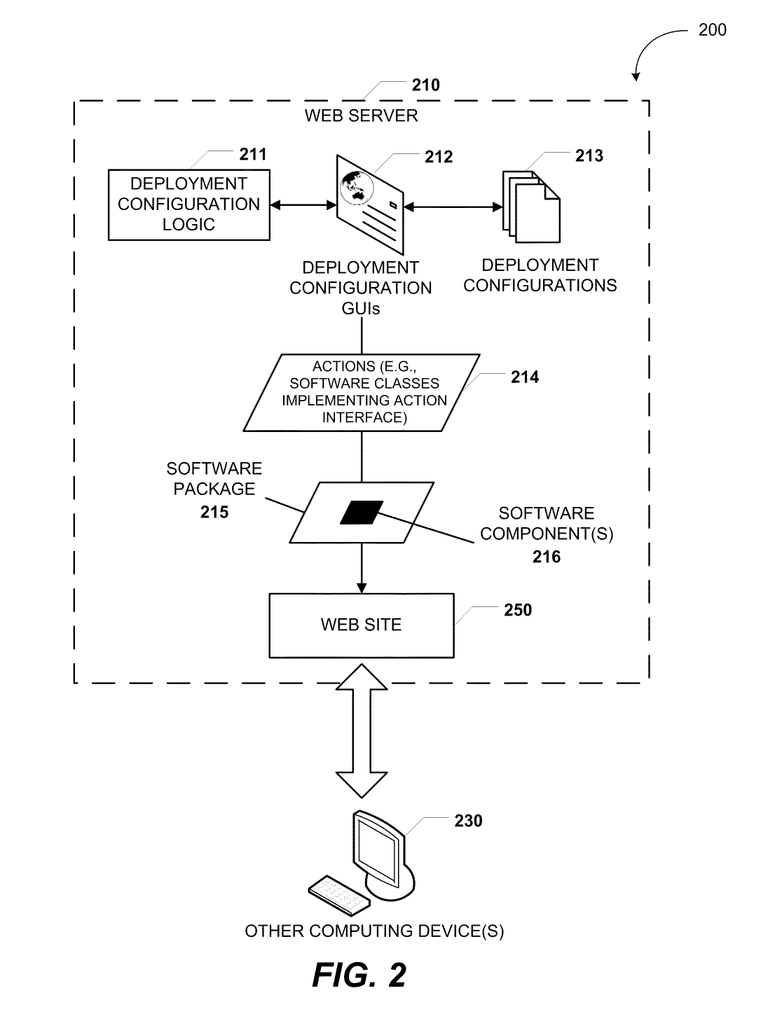

FIG. 1 depicts a particular embodiment of a system 100 for configuring software deployment. In the particular embodiment illustrated in FIG. 1, software deployment for a software package 115 may be configured at a first computing device 110, and the software package 115 may be deployed in accordance with the configuration to a second computing device 150 (e.g., a web server remotely located from the first computing device 110). In alternate embodiments, the deployment may be configured and the software package may be deployed at the same computing device. For example, deployment may be configured and the software package may be deployed at a server, as described and illustrated with reference to FIG. 2.

The first computing device 110 includes deployment configuration logic 111 to generate deployment configuration GUIs 112 that are useable to create, edit, and identify one or more deployment configurations 113 associated with the software package 115. In a particular embodiment, the software package 115 may include one or more software components (e.g., files or classes), as illustrated by the software components 116. Each of the deployment configurations 113 may include a sequence of install actions and a sequence of retract actions. For example, the deployment configurations 113 may include a clean deployment configuration or an upgrade deployment configuration. A clean deployment may involve deleting a previous version of the software package followed by reinstalling the software package. An upgrade deployment may include transmitting only changed software components of the software package to the second computing device 150. The deployment configurations 113 may include a default deployment configuration, pre-defined deployment configurations, and user-defined deployment configurations.

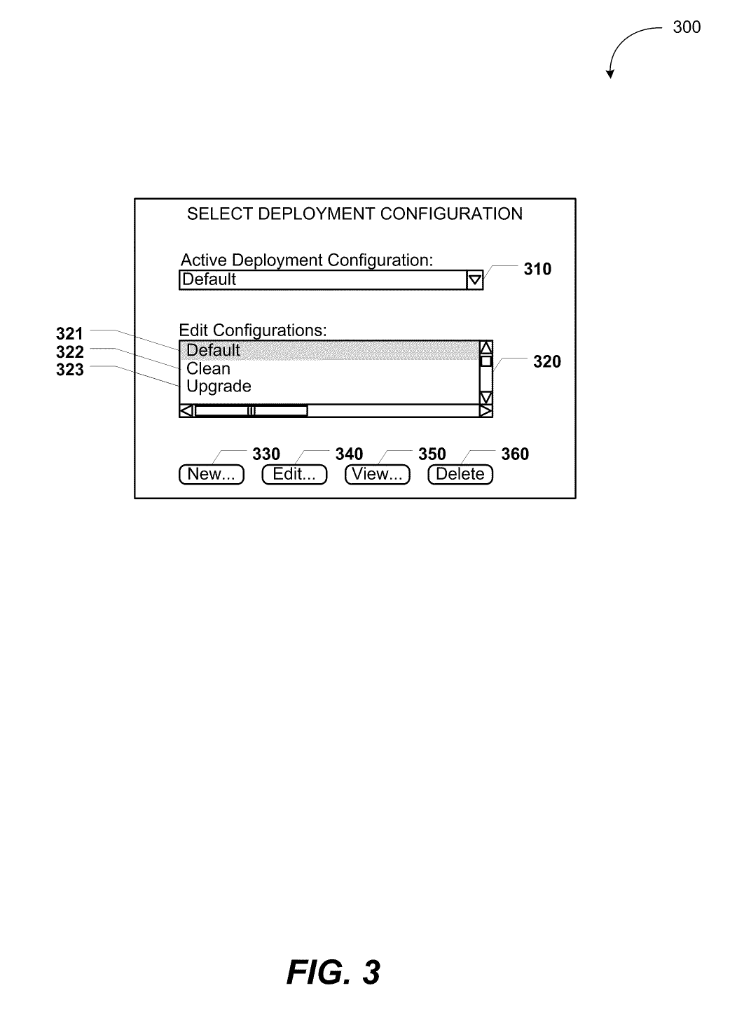

The deployment configurations 113 may be created, selected, and defined via the deployment configuration GUIs 112 based on user input. For example, the deployment configuration GUIs 112 may be used to define a first sequence of deployment actions that are executable to install the software package 115 at the second computing device 150. The first sequence of deployment actions may be selected from a list of available deployment actions. One or more actions in the list of available deployment actions may be a user-defined action. Similarly, the deployment configuration GUIs 112 may be used to define a second sequence of deployment actions that are executable to retract the software package 115 from the second computing device 150. In a particular embodiment, the deployment configuration GUIs 112 are further useable to reorder the install sequence of steps and the retract sequence of steps associated with each of the deployment configurations 113. The deployment configuration logic 111, the deployment configuration GUIs 112, and the deployment configurations 113 may be located at an integrated development environment (IDE) at the first computing device 110 that is useable to create and edit source code corresponding to the software package 115. Deployment configurations and deployment configuration GUIs are further described and illustrated with reference to FIGS. 3-5. It should be noted that although the particular embodiments illustrate GUIs, non-graphical UIs may also be used. For example, a text-based UI may be used to create and edit the deployment configurations 113. It should also be noted that deployment configurations may also be programmatically added (e.g., via extensions to a software development project).

In operation, the one or more deployment configurations 113 for the software package 115 may be created and edited using the deployment configuration GUIs 112. When an install operation associated with one of the deployment configurations 113 is selected, the first computing device 110 may transmit the software package 115 and actions 114 to the second computing device 150 (e.g., via a network 140). In a particular embodiment, the actions 114 instruct the second computing device 150 how to install the software package 115 such that the software package 115 and software components 116 are accessible and executable via the second computing device 150. For example, a third computing device 130 and other computing devices 120 may execute the software components 116 via a connection to the second computing device 150. When a retract operation associated with one of the deployment configurations 113 is selected, the first computing device 110 may transmit the actions 114 to the second computing device 150, where the actions 114 instruct the second computing device 150 how to retract (e.g., uninstall) the software package 115. In a particular embodiment, the actions 114 (e.g., installation or retraction actions) are software classes implementing one or more action interfaces. For example, each of the actions 114 may be software classes that implement a common “DeploymentAction” interface. The actions 114 may specify an installation location (e.g., folder or directory at the second computing device 150) and may include other commands executable by the second computing device 150.

It will be appreciated that the system 100 of FIG. 1 may enable configurable deployment of the software package 115. For example, the configuration deployment GUIs 112 may be used to create new deployment configurations 113 and edit existing deployment configurations 113. It will thus be appreciated that the system 100 of FIG. 1 may enable software developers to create custom deployment configurations that are better-suited to particular deployment scenarios than pre-defined deployment configurations. For example, when only a few software components of an application have changed, a software developer may create and use a faster-executing upgrade deployment configuration to replace only the changed software components instead of a slower-executing pre-defined clean deployment configuration that deletes and reinstalls the entire application.

FIG. 2 depicts another particular embodiment of a system 200 for configuring software deployment. In the particular embodiment illustrated in FIG. 2, a software package 215 may be developed at a web server 210 and deployed to a web site 250 hosted at the web server 210.

The web server 210 may include deployment configuration logic 211 to generate deployment configuration GUIs 212 that are useable to create, edit, and identify one or more deployment configurations associated with the software package 215. The deployment configuration logic 211, deployment configuration GUIs 212, deployment configurations 213, actions 214, software package 215, and software components 216 may be the same as the deployment configuration logic 111, the deployment configuration GUIs 112, the deployment configurations 113, the actions 114, the software package 115, and the software components 116 of FIG. 1.

The web site 250 may be accessible to one or more other computing devices 230. For example, the web site 250 may provide shared access to shared documents, shared calendars, shared hyperlinks, shared lists, shared folders, shared files, shared contacts, shared tasks, and shared applications (e.g., an application that includes the software components 216 of the software package 215). In a particular embodiment, the web site 250 is a Sharepoint® web site. Sharepoint® is a registered trademark of Microsoft Corporation, located at One Microsoft Way, Redmond, Wash. 98052.

In operation, the one or more deployment configurations 213 may be created and edited using the deployment configuration GUIs 212. When an install operation associated with one of the deployment configurations 213 is selected, the software package 115 may be installed at the web site 250, as specified by the actions 214, such that the software package 215 becomes accessible to and executable by the other computing devices 230. When a retract operation associated with one of the deployment configurations 113 is selected, the software package 215 may be retracted from the web site 250, as specified by the actions 114.

It will be appreciated that the system 200 of FIG. 1 may enable configurable deployment of the software package 215, where software deployment and software development occur at the same computing device. For example, the configuration deployment GUIs 212 may be used to create new deployment configurations 213 and edit existing deployment configurations 213. It will thus be appreciated that the system 200 of FIG. 2 may enable software developers to create custom deployment configurations that are better-suited to particular software deployment situations than pre-defined deployment configurations.

FIG. 3 depicts a particular embodiment of a GUI 300 that is useable to configure software deployments. In an illustrative embodiment, the GUI 300 is one of the configuration deployment GUIs 112 of FIG. 1 or one of the configuration deployment GUIs 212 of FIG. 2.

The GUI 300 may include a GUI element to identify an active deployment configuration 310. For example, in the particular embodiment illustrated in FIG. 3, the active deployment configuration 310 may be “Default” (e.g., a default deployment configuration).

The GUI 300 may also include a list 320 of available deployment configurations. For example, the available deployment configurations may include the default deployment configuration 321, a clean deployment configuration 322, and an upgrade deployment configuration 323. One or more of the deployment configurations may be user-defined. For example, the upgrade deployment configuration 323 may be user defined. The GUI 300 may further include one or more GUI buttons. For example, the GUI 300 may include a new button 330 to create a new deployment configuration and add the new deployment configuration to the list 320, an edit button 340 to edit an existing deployment configuration from the list 320, a view button 350 to view installation and retraction steps for an existing deployment configuration from the list 320, and a delete button 360 to delete an existing deployment configuration from the list 320.

It will be appreciated that the GUI 300 of FIG. 3 may provide a list of available deployment configurations and may enable users to create, edit, and view deployment configurations. It will thus be appreciated that the GUI 300 of FIG. 3 may be part of a deployment configuration interface (e.g., at an IDE) that is displayed when a software developer builds a software application.

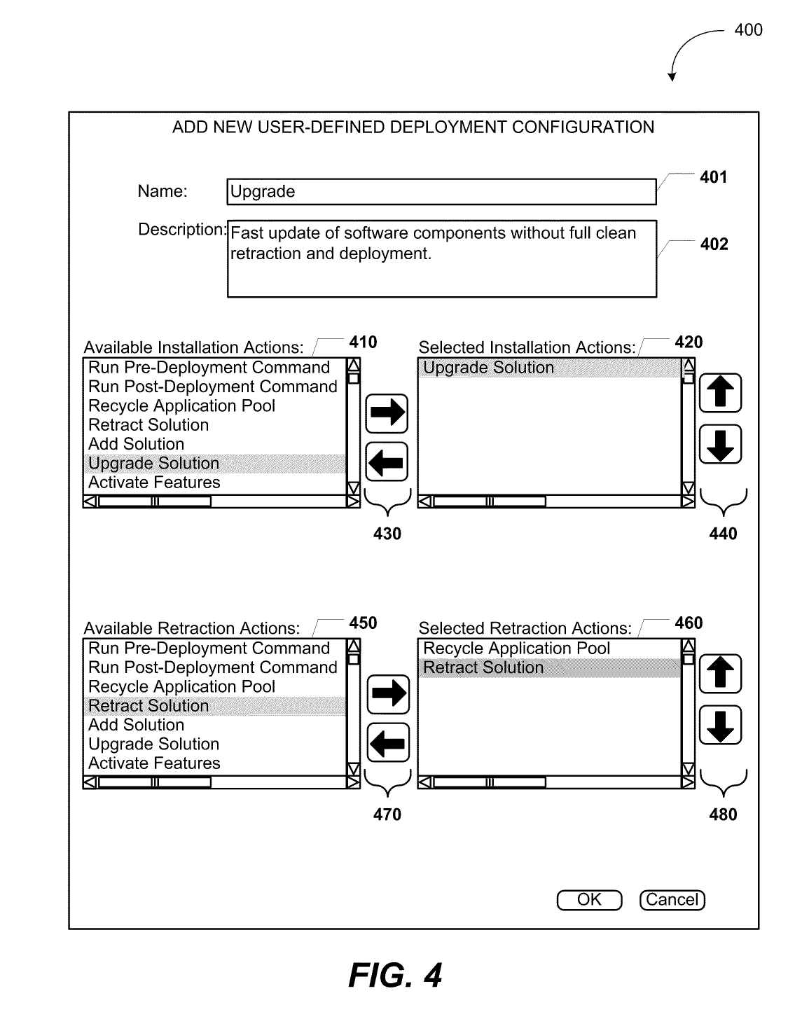

FIG. 4 depicts a particular embodiment of a GUI 400 that is useable to add a new user-defined deployment configuration. For example, the GUI 400 may be used to create the upgrade deployment configuration 323 of FIG. 3. In an illustrative embodiment, the GUI 400 is one of the configuration deployment GUIs 112 of FIG. 1 or one of the configuration deployment GUIs 212 of FIG. 2.

The GUI 400 may include text boxes useable by a user to provide a name 401 and a description 402 of the deployment configuration. The GUI 400 may also include a list of available installation actions 410. For example, in the particular embodiment illustrated in FIG. 4, the available installation actions 410 include a run pre-deployment command action, a run post-deployment command action, a recycle application pool action, a retract solution action, an add solution action, an upgrade solution action, and an activate features action. One or more of the available installation actions 410 may be user-defined.

The run pre-deployment command action may be configured to execute a pre-deployment command (e.g., an operating system command or a shell script) before any other installation actions are executed. The run post-deployment command action may be configured to execute a post-deployment command (e.g., an operating system command or a shell script) after all other installation actions are executed. The recycle application pool action may be configured to stop execution of worker threads (e.g., threads associated with a previously deployed software package). The add solution action may be configured to copy a software package to an installation location (e.g., a web site). The upgrade solution action may be configured to update a software package to a current version (e.g., by overwriting old software components of the software package with updated software components). The activate features action may be configured to activate one or more features of a software package. The retract solution action may be configured to deactivate the one or more features of the software package and to delete the software package from the installation location.

The GUI 400 may further include a list of selected installation actions 420. For example, the selected installation actions 420 for the upgrade deployment configuration may include the upgrade solution action. The GUI 400 may be operable to add and remove installation actions to and from the selected installation actions 420 (e.g., via a first add/remove control 430). The GUI 400 may also be operable to reorder the selected installation actions 420 (e.g., via a first reorder control 440).

The GUI 400 may include a list of available retraction actions 450. In a particular embodiment, the list of available retraction actions 450 is the same as the list of available installation actions 410. For example, the list of available retraction actions 450 and the list of available installation actions 410 may be based on a common list of available actions. One or more of the available retraction actions 450 may be user-defined.

The GUI may also include a list of selected retraction actions 460. For example, the selected retraction actions 460 for the upgrade deployment configuration may include the recycle application pool action and the retract solution action. The GUI 400 may be operable to add and remove retraction actions to and from the selected retraction actions 460 (e.g., via a second add/remove control 470). The GUI 400 may also be operable to reorder the selected retraction actions 460 (e.g., via a second reorder control 480).

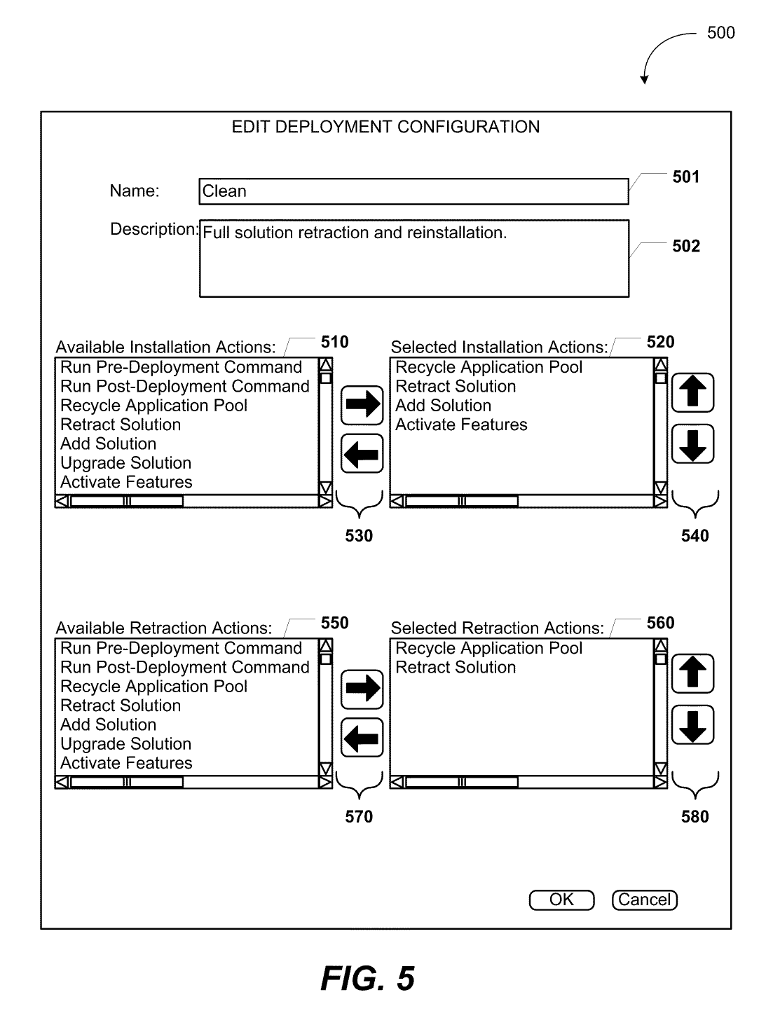

FIG. 5 depicts a particular embodiment of a GUI 500 that is useable to edit an existing deployment configuration. For example, the GUI 500 may be used to edit the clean deployment configuration 322 of FIG. 3. In an illustrative embodiment, the GUI 500 is one of the configuration deployment GUIs 112 of FIG. 1 or one of the configuration deployment GUIs 212 of FIG. 2.

The GUI 500 may include text boxes to edit a name 501 and a description 502 of the deployment configuration. The GUI 400 may also include a list of available installation actions 510, a list of available retraction actions 550, selected installation actions 520, and selected retraction actions 560. For example, the selected installation actions 520 for the clean deployment configuration may include the recycle application pool action, the retract solution action, the add solution action, and the activate features action. The selected retraction actions 560 may include the recycle application pool action and the retract solution action.

The GUI 500 may be operable to add and remove installation actions to and from the selected installation actions 520 (e.g., via a first add/remove control 530) and to reorder the selected installation actions 520 (e.g., via a first reorder control 540). The GUI 500 may also be operable to add and remove retraction actions to and from the selected retraction actions 560 (e.g., via a second add/remove control 570) and to reorder the selected retraction actions 560 (e.g., via a second reorder control 580).

It will be appreciated that the GUIs 400, 500 of FIGS. 4-5 may provide a list of available installation and retraction actions and may enable users to select and reorder particular sequences of installation and retraction actions for particular deployment configurations.

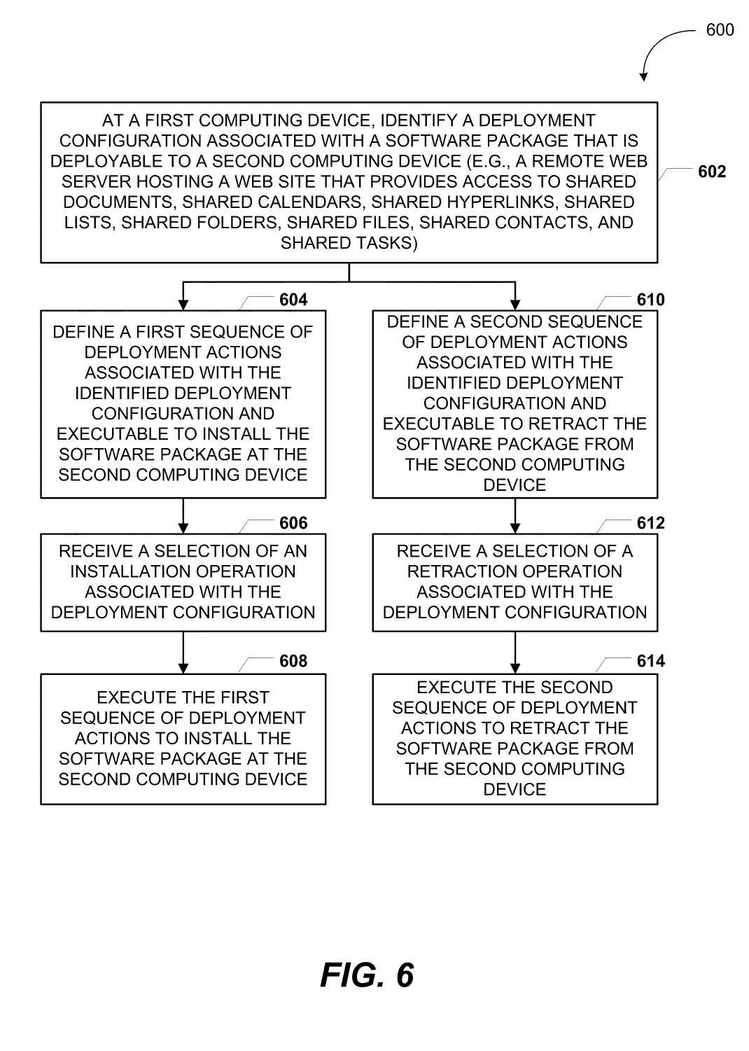

FIG. 6 depicts a particular embodiment of a method 600 of configuring a software deployment. In an illustrative embodiment, the method 600 may be performed at the system 100 of FIG. 1 or the system 200 of FIG. 2, and may be illustrated with reference to the GUIs 300, 400, 500 of FIGS. 3-5.

The method 600 includes, at a first computing device, identifying a deployment configuration associated with a software package that is deployable to a second computing device, at 602. In a particular embodiment, the second computing device is a remote web server hosting a web site that provides access to shared documents, shared calendars, shared hyperlinks, shared lists, shared folders, shared files, shared contacts, and shared tasks. For example, in FIG. 1, one of the deployment configurations 113 associated with the software package 115 may be identified.

The method 600 also includes installing the software package, at 604-606, or retracting the software package, at 610-614. The installation of the software package may include defining a first sequence of deployment actions that are associated with the identified deployment configuration and that are executable to install the software package at the second computing device, at 604. For example, a sequence of install actions may be defined using the deployment configuration GUIs 112 of FIG. 1. In a particular embodiment, the install actions may be selected as illustrated by the selected installation actions 420 of FIG. 4 or the selected installation actions 520 of FIG. 5.

Installing the software package may also include receiving a selection of an installation operation associated with the deployment configuration, at 606, and executing the first sequence of deployment actions to install the software package at the second computing device, at 608. For example, in FIG. 1, the software package 215 may be installed at the second computing device 150, in accordance with the actions 114.

Retracting the software package may include defining a second sequence of deployment actions that are associated with the identified deployment configuration and that are executable to retract the software package from the second computing device, at 610. For example, a sequence of retract actions may be defined using the deployment configuration GUIs 112 of FIG. 1. In a particular embodiment, the retract actions may be selected as illustrated by the selected retraction actions 460 of FIG. 4 or the selected retraction actions 560 of FIG. 5.

Retracting the software package may also include receiving a selection of a retraction operation associated with the deployment configuration, at 612, and executing the second sequence of deployment actions to retract the software package from the second computing device, at 614. For example, in FIG. 1, the software package 215 may be retracted from the second computing device 150 based on the actions 114.

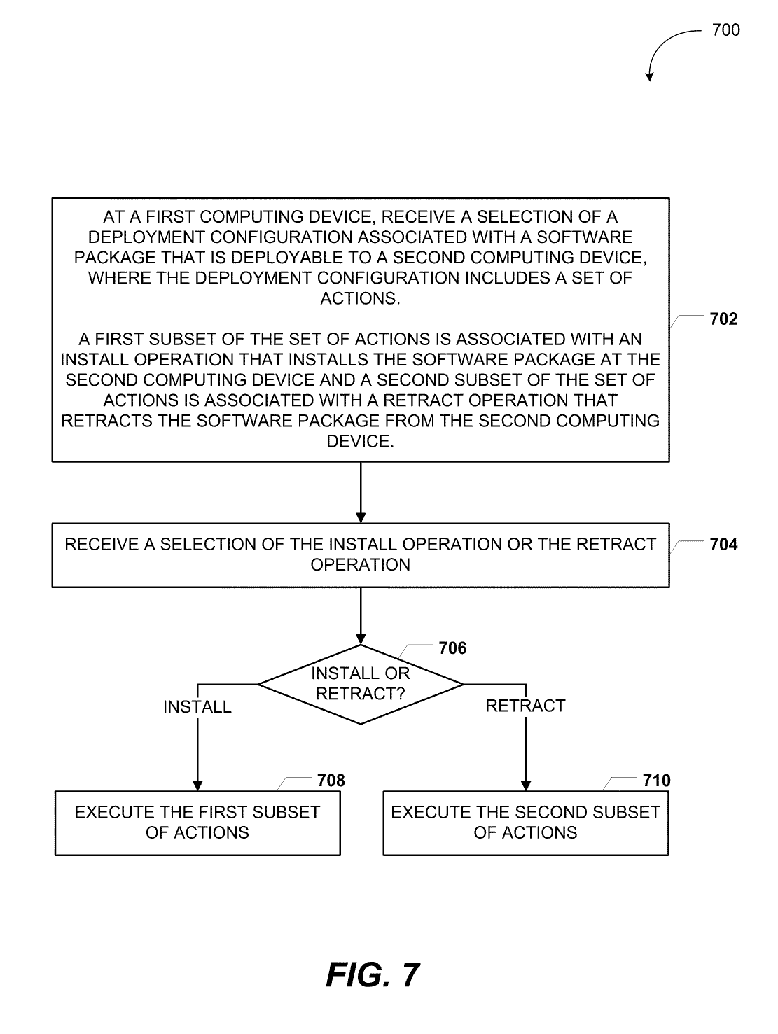

FIG. 7 is a flow diagram to illustrate a particular embodiment of a method 700 of configuring and executing software deployment or retraction. In an illustrative embodiment, the method 700 may be performed at the system 100 of FIG. 1 or the system 200 of FIG. 2, and may be illustrated with reference to the GUIs 300, 400, 500 of FIGS. 3-5.

The method 700 includes, at a first computing device, receiving a selection of a deployment configuration associated with a software package that is deployable to a second computing device, at 702. The deployment configuration includes a set of actions. A first subset of actions is associated with an install operation that installs the software package at the second computing device and a second subset of actions is associated with a retract operation that retracts the software package from the second computing device. For example, in FIG. 1, one of the deployment configurations 113 associated with the software package 115 may be selected. In a particular embodiment, the set of actions includes the run pre-deployment command action, the run post-deployment command action, the recycle application pool action, the retract solution action, the add solution action, the upgrade solution action, and the activate features action, as illustrated with reference to FIGS. 4-5.

The method 700 also includes receiving a selection of the install operation or the retract operation, at 704. For example, in FIG. 1, the install operation or the retract operation of one of the deployment configurations 113 may be selected.

The method 700 further includes determining whether the install or retract operation was selected, at 706. When the install operation is selected, the method 700 includes executing the first subset of actions, at 708. For example, in FIG. 1, the software package 115 may be installed at the second computing device 150. In a particular embodiment, the first subset of actions includes the selected installation actions 420 of FIG. 4 or the selected installation actions 520 of FIG. 5. When the retract operation is selected, the method 700 includes executing the second subset of actions. For example, in FIG. 1, the software package 115 may be retracted from the second computing device 150. In a particular embodiment, the second subset of actions includes the selected retraction actions 460 of FIG. 4 or the selected retraction actions 560 of FIG. 5.

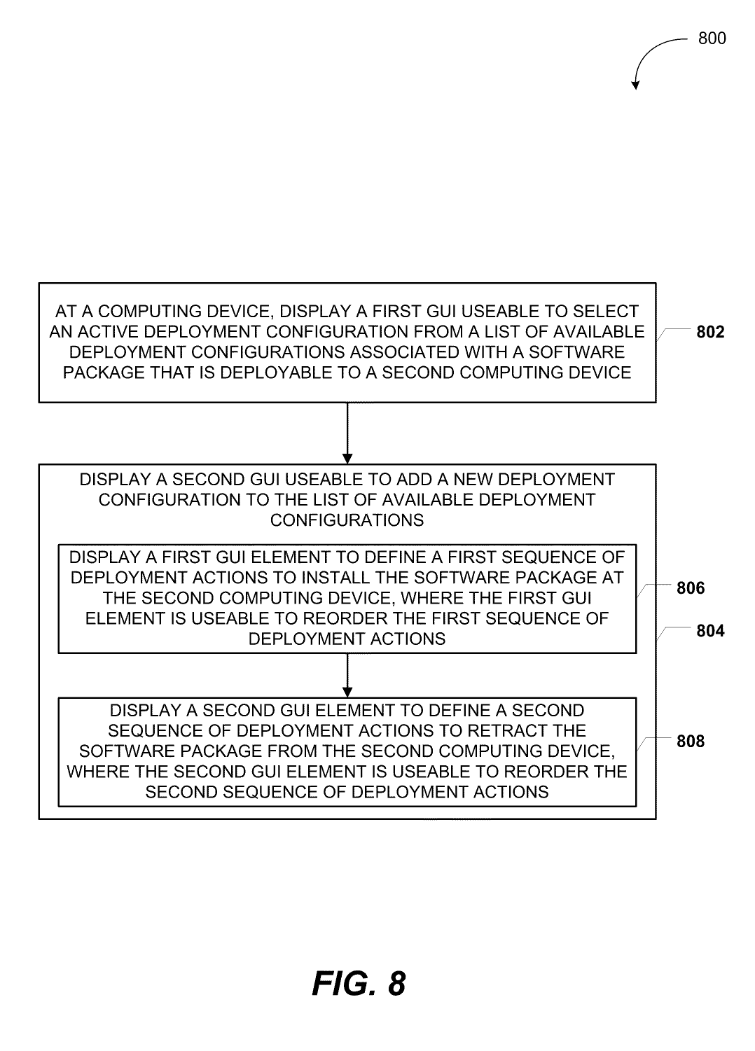

FIG. 8 is a flow diagram to illustrate a particular embodiment of a method 800 of providing GUIs that are usable to configure software deployment. In an illustrative embodiment, the method 800 may be performed at the system 100 of FIG. 1 or the system 200 of FIG. 2, and may be illustrated with reference to the GUIs 300, 400 of FIGS. 3-4.

The method 800 includes, at a computing device, displaying a first GUI useable to select an active deployment configuration from a list of available deployment configurations associated with a software package that is deployable to a second computing device, at 802. For example, in FIG. 1, a first GUI of the deployment configuration GUIs 112 may be displayed. In an illustrative embodiment, the first GUI is the GUI 300 of FIG. 3.

The method 800 also includes displaying a second GUI usable to add a new deployment configuration to the list of available deployment configurations, at 804. For example, in FIG. 1, a second GUI of the deployment configuration GUIs 112 may be displayed. In an illustrative embodiment, the second GUI is the GUI 400 of FIG. 4 (e.g., the second GUI displayed in response to detecting a push of the new button 330 of FIG. 3).

Displaying the second GUI includes displaying a first GUI element to define a first sequence of deployment actions to install the software package at the second computing device, where the first GUI element is useable to reorder the first sequence of deployment actions, at 806. For example, the list of available installation actions 410, the selected installation actions 420, the first add/remove control 430, and the first reorder control 440 of FIG. 4 may be displayed.

Displaying the second GUI also includes displaying a second GUI element to define a second sequence of deployment actions to retract the software package from the second computing device, where the second GUI element is useable to reorder the second sequence of deployment actions, at 808. For example, the list of available retraction actions 450, the selected retraction actions 460, the second add/remove control 470, and the second reorder control 480 of FIG. 4 may be displayed.

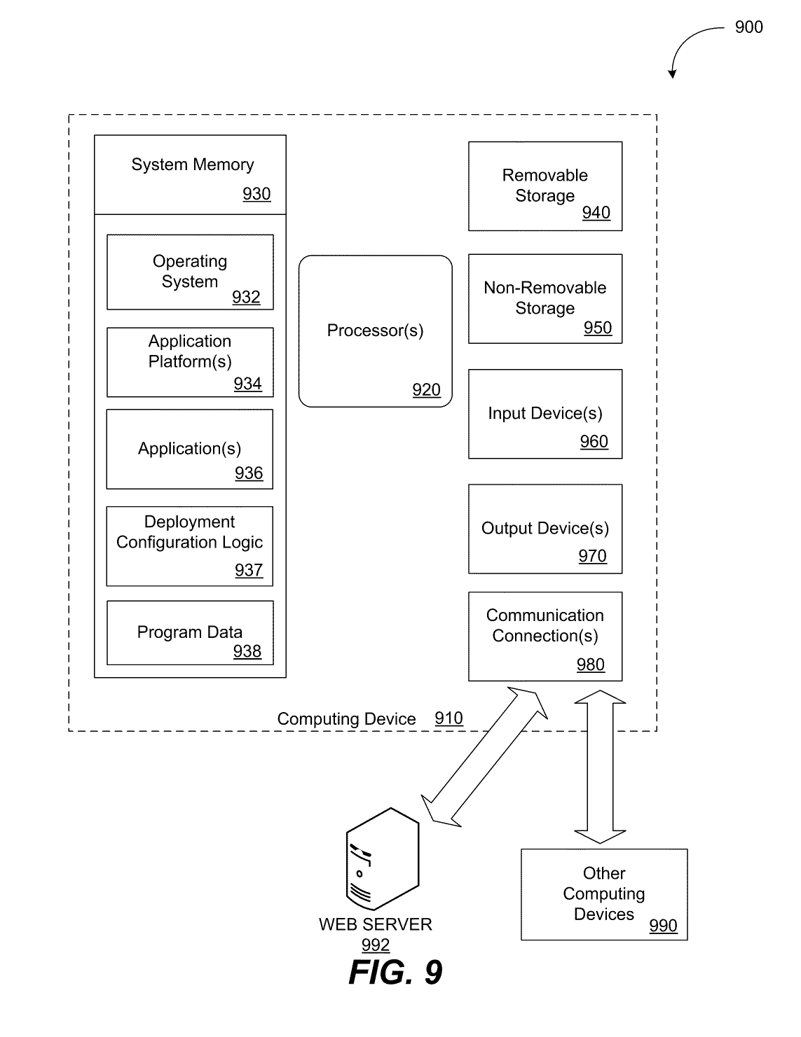

FIG. 9 depicts a block diagram of a computing environment 900 including a computing device 910 operable to support embodiments of computer-implemented methods, computer program products, and system components according to the present disclosure. In an illustrative embodiment, the computing device 910 may include one or more of the first computing device 110 of FIG. 1, the second computing device 150 of FIG. 1, the third computing device 130 of FIG. 1, the other computing devices 120 of FIG. 1, the server 210 of FIG. 2, and the other computing devices 230 of FIG. 2, or components thereof. Each of the first computing device 110 of FIG. 1, the second computing device 150 of FIG. 1, the third computing device 130 of FIG. 1, the other computing devices 120 of FIG. 1, the server 210 of FIG. 2, and the other computing devices 230 of FIG. 2, or components thereof, may include or be implemented using the computing device 910 or a portion thereof.

The computing device 910 includes at least one processor 920 and a system memory 930. Depending on the configuration and type of computing device, the system memory 930 may be volatile (such as random access memory or “RAM”), non-volatile (such as read-only memory or “ROM,” flash memory, and similar memory devices that maintain stored data even when power is not provided), or some combination of the two. The system memory 930 typically includes an operating system 932, one or more application platforms 934, one or more applications, and program data 938. The system memory 930 may also include deployment configuration logic 937. In an illustrative embodiment, the deployment configuration logic 937 is the deployment configuration logic 111 of FIG. 1 or the deployment configuration logic 211 of FIG. 2.

The computing device 910 may also have additional features or functionality. For example, the computing device 910 may also include removable and/or non-removable additional data storage devices such as magnetic disks, optical disks, tape, and standard-sized or flash memory cards. Such additional storage is illustrated in FIG. 9 by removable storage 940 and non-removable storage 950. Computer storage media may include volatile and/or non-volatile storage and removable and/or non-removable media implemented in any technology for storage of information such as computer-readable instructions, data structures, program components or other data. The system memory 930, the removable storage 940 and the non-removable storage 950 are all examples of computer storage media. The computer storage media includes, but is not limited to, RAM, ROM, electrically erasable programmable read-only memory (EEPROM), flash memory or other memory technology, compact disks (CD), digital versatile disks (DVD) or other optical storage, magnetic cassettes, magnetic tape, magnetic disk storage or other magnetic storage devices, or any other medium that can be used to store information and that can be accessed by the computing device 910. Any such computer storage media may be part of the computing device 910.

The computing device 910 may also have input device(s) 960, such as a keyboard, mouse, pen, voice input device, touch input device, etc. Output device(s) 970, such as a display, speakers, printer, etc. may also be included. In an illustrative embodiment, the input device(s) 960 and the output device(s) 970 may enable interaction with deployment configuration GUIs such as one or more of the deployment configuration GUIs 112 of FIG. 1, the deployment configuration GUIs 212 of FIG. 2, the GUI 300 of FIG. 3, the GUI 400 of FIG. 4, and the GUI 500 of FIG. 5.

The computing device 910 also contains one or more communication connections 980 that allow the computing device 910 to communicate with other computing devices 990 over a wired or a wireless network. In an illustrative embodiment, the other computing devices 990 may include the computing devices 120, 130, or 150 of FIG. 1 or the other computing devices 230 of FIG. 2. The one or more communications connections 980 may also enable communications with a web server 992. In an illustrative embodiment, the web server 992 is the second computing device 150 of FIG. 1 or the web server 210 of FIG. 2.

It will be appreciated that not all of the components or devices illustrated in FIG. 9 or otherwise described in the previous paragraphs are necessary to support embodiments as herein described. For example, the removable storage 940 may be optional.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Accordingly, the disclosure and the figures are to be regarded as illustrative rather than restrictive.

Those of skill would further appreciate that the various illustrative logical blocks, configurations, modules, and process steps or instructions described in connection with the embodiments disclosed herein may be implemented as electronic hardware or computer software. Various illustrative components, blocks, configurations, modules, or steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The steps of a method described in connection with the embodiments disclosed herein may be embodied directly in hardware, in a software module executed by a processor, or in a combination of the two. A software module may reside in computer readable media, such as random access memory (RAM), flash memory, read only memory (ROM), registers, a hard disk, a removable disk, a CD-ROM, or any other form of storage medium known in the art. An exemplary storage medium is coupled to a processor such that the processor can read information from, and write information to, the storage medium. In the alternative, the storage medium may be integral to the processor or the processor and the storage medium may reside as discrete components in a computing device or computer system.

Although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments.

The Abstract of the Disclosure is provided with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments.

The previous description of the embodiments is provided to enable a person skilled in the art to make or use the embodiments. Various modifications to these embodiments will be readily apparent to those skilled in the art, and the generic principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims.

What is claimed is:

1. A computer-implemented method, comprising:
at a first computing device, identifying a deployment configuration associated with a software package that is deployable to a second computing device;
defining a first sequence of deployment actions selected from a list of available deployment actions associated with the identified deployment configuration, wherein the first sequence of deployment actions is executable to install the software package at the second computing device;
receiving a selection of an installation operation associated with the deployment configuration; and
executing the first sequence of deployment actions to install the software package at the second computing device.

2. The computer-implemented method of claim 1, further comprising defining a second sequence of deployment actions selected from the list of available deployment actions, wherein the second sequence of deployment actions is executable to retract the software package from the second computing device.

3. The computer-implemented method of claim 2, further comprising:
receiving a selection of a retraction operation associated with the deployment configuration; and
executing the second sequence of deployment actions to retract the software package from the second computing device.

4. The computer-implemented method of claim 1, wherein the list of available deployment actions includes:
a run pre-deployment command action configured to execute a pre-deployment command,
a run post-deployment command action configured to execute a post-deployment command,
a recycle application pool action configured to stop execution of worker threads at the second computing device,
an add solution action configured to copy the software package to the second computing device,
an activate features action configured to activate one or more features of the software package,
an upgrade solution action configured to update the software package to a current version, and
a retract solution action configured to deactivate the one or more features of the software package and to delete the software package from the second computing device.

5. The computer-implemented method of claim 4, wherein the deployment configuration is a clean deploy configuration.

6. The computer-implemented method of claim 5, wherein the first sequence of deployment actions comprises the recycle application pool action, the retract solution action, the add solution action, and the activate feature action.

7. The computer-implemented method of claim 5, wherein the second sequence of deployment actions comprises the recycle application pool action and the retract solution action.

8. The computer-implemented method of claim 4, wherein the deployment configuration is an upgrade configuration.

9. The computer-implemented method of claim 8, wherein the first sequence of deployment actions comprises the upgrade solution action.

10. The computer-implemented method of claim 8, wherein the second sequence of actions comprises the recycle application pool action and the retract solution action.

11. The computer-implemented method of claim 1, wherein the second computing device is a web server that is remotely located from the first computing device.

12. The computer-implemented of claim 11, wherein the web server hosts a web site that provides a third computing device shared access to a shared document, a shared calendar, a shared hyperlink, a shared list, a shared folder, a shared file, a shared contact, a shared task, or any combination thereof.

13. The computer-implemented method of claim 1, wherein the deployment configuration is a default configuration or a user-defined configuration.

14. The computer-implemented method of claim 13, wherein the deployment configuration is the user-defined configuration and wherein the list of available deployment actions includes one or more user-defined deployment actions.

15. The computer-implemented method of claim 14, further comprising displaying a user interface (UI) to receive user input associated with the user-defined configuration and the one or more user-defined deployment actions.

16. The computer-implemented method of claim 1, wherein the software package comprises one or more components of a software application that are executable via the second computing device.

17. A computer-readable medium comprising instructions, that when executed by a computer, cause the computer to:
receive a selection of a deployment configuration associated with a software package that is deployable to a second computing device, wherein the deployment configuration comprises a set of actions, wherein a first subset of the set of actions is associated with an install operation to install the software package at the second computing device, and wherein a second subset of set actions is associated with a retract operation to retract the software package from the second computing device;
receive a selection of one of the install operation and the retract operation;
execute the first subset of actions when the install operation is selected; and
execute the second subset of actions when the retract operation is selected.

18. The computer-readable medium of claim 17, wherein at least one action of the set of actions is represented by a software class that implements an action interface.

19. A computer-readable medium comprising instructions, that when executed by a computer, cause the computer to:
display a first graphical user interface (GUI) useable to select an active deployment configuration from a list of available deployment configurations associated with a software package that is deployable to a second computing device; and
display a second GUI useable to add a new deployment configuration to the list of available deployment configurations, wherein the second GUI comprises:
a first GUI element to define a first sequence of deployment actions to install the software package at the second computing device; and
a second GUI element to define a second sequence of deployment actions to retract the software package from the second computing device.

20. The computer-readable medium of claim 19, wherein the first GUI element is useable to reorder the first sequence of deployment actions and the second GUI element is useable to reorder the second sequence of deployment actions.
